(19) United States
(12) Patent Application Publication
(10) Pub. No.: US 2018/0054981 A1
(43) Pub. Date: Mar. 1, 2018

(54) INSECT-TRAPPING HORTICULTURAL COVER, SYSTEM AND METHOD OF MANUFACTURE

(71) Applicant: Bradly Work, Prince George (CA)

(72) Inventor: Bradly Work, Prince George (CA)

(21) Appl. No.: 15/803,685

(22) Filed: Nov. 3, 2017

Related U.S. Application Data
(63) Continuation-in-part of application No. 15/180,750, filed on Jun. 13, 2016, now abandoned.
Application No. 15/180,750 is a continuation-in-part of application No. 14/088,181, filed on Nov. 22, 2013, now abandoned.
(60) Provisional application No. 61/847,964, filed on Jul. 18, 2013.

(51) Int. Cl. A01G 13/10; A01M 1/14; A01M 1/02; A01M 29/08; A01M 29/12; A01M 1/20; A01G 13/02

(52) U.S. Cl. CPC A01G 13/105; A01M 1/145; A01M 1/023; A01G 2013/006; A01M 29/12; A01M 1/2005; A01G 13/02; A01M 29/08

(57) ABSTRACT

An adhesive pest trap is provided, that includes: a substantially planar substrate having first and second substantially parallel surfaces and an outer perimeter, wherein the first surface includes a non-drying adhesive material coating, and wherein the outer perimeter is configured for fitting within a rim of a plant growing container. In one example, an adhesive pest trap can be adapted to cover a soil surface in a plant growing container, where a perimeter of the adhesive pest trap additionally includes one or more attachable surfaces adapted for attachment to a rim of a plant growing container. A related method of using an adhesive pest trap includes applying the adhesive pest trap over a top surface of a plant growing medium in a plant growing container.

### CROSS-REFERENCE TO RELATED APPLICATIONS

This second continuation in part application relates to and claims priority to the first continuation in part application Ser. No. 15/180,750, filed Jun. 13, 2016, entitled “Insect-Trapping Horticultural Cover, System and Method of Manufacture”, which relates to U.S. patent application Ser. No. 14/088,181, filed Nov. 22, 2013, entitled “Adhesive Pest Trap”, and incorporates by reference U.S. provisional patent application 61/847,964, filed Jul. 18, 2013, entitled “Adhesive Pest Trap”, the contents all of which are incorporated herein by reference in their entirety.

### BACKGROUND

### Field of the Invention

The present invention relates generally to adhesive or non-drying glue based pest traps. More specifically, the present invention relates to adhesive or non-drying glue based pest traps which are adapted to be applied to cover the soil surface of a plant growing container to protect a growing plant from pests, and methods of use thereof.

### Description of Related Art

Horticulture is the branch of agriculture that deals with the art, science, technology, and business of growing plants. Indoor horticulture typically includes, greenhouse growing, hydroponics, and indoor gardening. Hydroponics, in particular, is unique in that it is a method of growing plants using mineral nutrient solutions, in water, without soil. Terrestrial plants may be grown with their roots in the mineral solution only, or in an inert medium, such as perlite or gravel. However, hydroponics present unique considerations not normally present in soil-based growing.

While indoor grow operations may provide some deterrent to pests compared to outdoor horticulture, particularly with crawling insects, they still remain a problem for growers. This is particularly true for flying and transported pests (e.g., carried indoors as passengers of hosts), as they have greater mobility and may more easily enter an enclosed structure or home. Moreover, in indoor hydroponic applications, the grow operations may be more sensitive to intruders. For example, insects may introduce harmful bacteria and microorganisms into the inert medium. Also for example, the pests may be more intolerable where the hydroponics is located in a home environment

The widespread adoption of greenhouse or otherwise indoor horticulture and/or agriculture involving growing plants inside plant pots or growing containers has led to a need for improved methods of controlling pests who feed on or otherwise damage such plant pot or container-grown plants. In particular, there is a desire for improved traps for trapping or otherwise stopping or repelling pests, such as insects, arthropods, larvae, and others, that may crawl or land on, or burrow into soil surfaces in plant pots or containers so as to attack or otherwise disturb plants growing in the pots or containers. Examples of such pests may include but are not limited to gnats, aphids, whiteflies, spider mites, thrips, fruit flies and other types of flies, caterpillars, larvae, leafminers and fungus pests.

Many types of insect traps designed to capture and/or kill insects, both flying and crawling, have been proposed. One type of such traps use non-drying glues or other adhesives to trap insects by adhesive contact. Insect traps using such adhesive methods are well known and include coiled flypaper ribbons, and hanging flypaper sheets and/or boards. Other more complex known traps include non-drying glue or adhesive components with additional complexities such as trap enclosures or containers, attractants such as lights, and various shipping and/or storing capabilities.

However, existing insect trap products have been found to have limitations which have undesirably limited their usefulness and/or commercial success. They may be messy to deploy, unpleasant to look at or use, expensive or narrowly useful, or ineffective in use, among other limitations. They may also be unsuitable, inefficient or ineffective for application to pest control for plants growing in pots or plant containers.

For example, U.S. Pat. App. Pub. No. 2004/0216367 by Klein and published on Nov. 4, 2004 shows a non-drying adhesive tape role including diatomaceous earth treated insect control devices. In particular, the disclosure of Klein is directed toward simple device embodiments used for the spot control of insect pests such as a double sided tape with a standard contact adhesive on one side and a tacky, non-drying adhesive on the other side. The non-drying adhesive acts as an effective insect barrier when the tape is applied around a perimeter to restrict crawling insect passage. In particular, the tape acts more as a barrier than a trap, as the insects typically do not get completely stuck in the exposed adhesive, but are able to pull free and simply avoid trying to cross the tape in future encounters.

For crawling insects, this may offer some deterrent, however, leaping, falling, and/or flying insects merely need to go over the strip of tape. Moreover, even crawling insects may find opportunities to breach the barrier of a strip of tape, for example, at gaps between at the ends of each strip, at curled up ends losing adhesion, at arcs made by conforming the linear tape to a curved perimeter, etc. In addition, it may be unattractive, time consuming, and/or even complicated to lay a flat perimeter barrier (e.g., for a curved object such as a flower pot using several linear strips to form a polygon).

Accordingly, there remains a desire for improved adhesive pest traps and methods for their application that address some of the limitations of the adhesive pest traps known in the art. The present disclosure is directed toward overcoming known problems and/or problems discovered by the inventor.

### BRIEF SUMMARY OF THE INVENTION

An insect-trapping horticultural cover is disclosed herein. The insect-trapping horticultural cover includes a pliable substrate that is substantially planar, the pliable substrate having a top planar surface and a bottom planar surface, the top planar surface and the bottom planar surface being substantially parallel to each other and on opposing sides of the pliable substrate, the pliable substrate including: an outer perimeter edge between the top planar surface and the bottom planar surface, the bottom planar surface is configured to physically couple with a rim of a plant growing container wherein the bottom planar surface extends beyond the rim of the plant growing container wherein the bottom planar surface and the rim of the plant growing container together establish a continuous boundary around the plant growing container; an inner variable-perimeter edge between the top planar surface and the bottom planar surface, the inner variable-perimeter edge configured to substantially encircle an extruded portion of vegetation, and flexibly-sized and spaced so as to allow for the extruded portion of vegetation to protrude through during a life-cycle of the vegetation; a slit extending between and joining the outer perimeter edge to the inner perimeter edge; and a non-drying adhesive layer fixed to the top planar surface extending continuously over a majority of the top planar surface and extending beyond the rim of the plant growing container to and including the outer perimeter edge and configured to prevent an insect from escape after coming into physical contact with the non-drying adhesive layer; wherein the pliable substrate is sufficiently pliable and resilient to deformably provide the extruded portion of vegetation passage from the outer perimeter edge to the inner perimeter edge, and to return to a substantially planar shape.

According to another embodiment, a system for protecting indoor plants is disclosed herein. The system for protecting indoor plants includes a plurality of pliable substrates that are substantially planar, each pliable substrate having a top planar surface and a bottom planar surface, with each top planar surface and bottom planar surface being substantially parallel to the other and on opposing sides of its respective pliable substrate. Each pliable substrate includes an outer perimeter edge between its top planar surface and its bottom planar surface, an inner perimeter edge between its top planar surface and its bottom planar surface, said inner perimeter edge configured to substantially encircle an extruded portion of vegetation, a slit extending between and joining the outer perimeter edge to the inner perimeter edge, and a non-drying adhesive layer fixed to said top planar surface and configured to prevent an insect from escape after coming into physical contact with said non-drying adhesive layer. The system for protecting indoor plants also includes a plurality of removable covers configured to prevent contact with each non-drying adhesive layer prior to removal of its respective removable cover. Each of the plurality of pliable substrates is sufficiently pliable and resilient to deformably provide the extruded portion of vegetation passage from its respective outer perimeter edge to its respective inner perimeter edge, and to return to a substantially planar shape. Each non-drying adhesive layer is interspersed between its respective removable cover and its respective pliable substrate.

According to another embodiment, a method of manufacturing a system for protecting indoor plants is also disclosed herein. The method of manufacturing a system for protecting indoor plants includes shaping a plurality of pliable substrates that are substantially planar, each pliable substrate having a top planar surface and a bottom planar surface, with each top planar surface and bottom planar surface being substantially parallel to each other and on opposing sides of their respective pliable substrate, each pliable substrate including an outer perimeter edge, an inner perimeter edge, and a slit extending between and joining said outer perimeter edge to said inner perimeter edge, such that each pliable substrate has a substantially annular shape, said inner perimeter edge configured to substantially encircle an extruded portion of vegetation. The method also includes fixing a plurality of non-drying adhesive layers to said top planar surface of each of the plurality of pliable substrates, each non-drying adhesive layer configured to prevent an insect from escape after coming into physical contact with said non-drying adhesive layer. The method also includes applying a plurality of removable covers to each of the plurality of non-drying adhesive layers, respectively, each non-drying adhesive layer being interspersed between its respective removable cover and its respective pliable substrate. The method also includes stacking together each of the plurality of pliable substrates having its respective non-drying adhesive layer fixed and its respective removable cover applied. In the method each of the plurality of pliable substrates is sufficiently pliable and resilient to deformably provide the extruded portion of vegetation passage from its respective outer perimeter edge to its respective inner perimeter edge, and to return to a substantially planar shape.

### BRIEF DESCRIPTION OF THE SEVERAL VIEWS OF THE DRAWINGS

The apparatus and methods of the present invention will now be described with reference to the accompanying drawing figures, in which:

FIG. 1 is a plan view of an adhesive pest trap according to an embodiment of the disclosure.

FIG. 2 is a top perspective view of an adhesive pest trap, according to an embodiment of the disclosure.

FIG. 3 is a top perspective view of an adhesive pest trap substantially encircling an extruded portion of vegetation and with its annular region being configured as a barrier and substantially covering a soil surface of a plant growing container, according to one exemplary embodiment of the disclosure.

FIG. 4 is a top perspective view of an adhesive pest trap applied to a soil surface of a plant growing container, according to a further embodiment of the disclosure.

FIG. 5 is a perspective side view of an adhesive pest trap, according to an embodiment of the disclosure.

FIG. 6 is a top view of an adhesive pest trap according to one embodiment, showing the pliable substrate as configured to permit water to pass.

FIG. 7 is a top view of an adhesive pest trap according to one embodiment, showing the pliable substrate with a plurality of arcuate perforations configured to permit water to pass.

FIG. 8 is a schematic diagram of a system for protecting indoor plants including a plurality of adhesive pest traps and a treatment means, according to one embodiment of the disclosure.

FIG. 9 is a schematic diagram of an adhesive pest trap on a conical configuration, according to one embodiment of the disclosure.

FIG. 10 is a top view of an adhesive pest trap according to an alternate embodiment, and configured to be stabbed in a medium.

FIG. 11 is a flow diagram showing method of manufacture, according to an embodiment of the disclosure.

### DETAILED DESCRIPTION

The nature, objectives, and advantages of the invention will become more apparent to those skilled in the art after considering the following disclosure in connection with the accompanying drawings. It is an object of the present invention to provide an adhesive pest trap that addresses some of the limitations of the prior art.

An adhesive pest trap is provided, that includes: a substantially planar substrate having first and second substantially parallel surfaces and an outer perimeter, wherein said first surface comprises a non-drying adhesive material coating, and wherein said outer perimeter is configured for fitting against a rim of a plant growing container.

A further object of the present invention is to provide an adhesive pest trap that is adapted to cover a soil surface in a plant growing container, wherein a perimeter of the adhesive pest trap additionally includes one or more attachable surfaces adapted for attachment to a rim of a plant growing container.

Another object of the present invention is to provide a method of using an adhesive pest trap comprising providing an adhesive pest trap, the method comprising providing an adhesive pest trap comprising a substantially planar substrate having first and second substantially parallel surfaces and an outer perimeter, wherein said first surface comprises a non-drying adhesive material coating, and wherein said outer perimeter is configured for fitting against a rim of a plant growing container, and applying the adhesive pest trap over the top surface of a plant growing medium in a plant growing container.

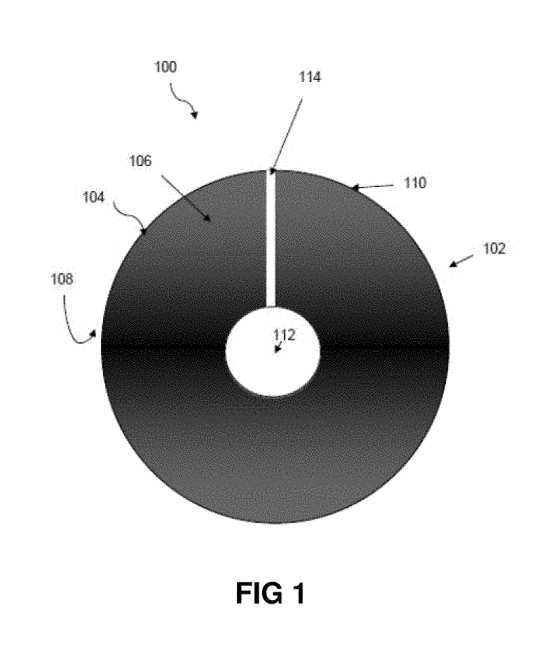

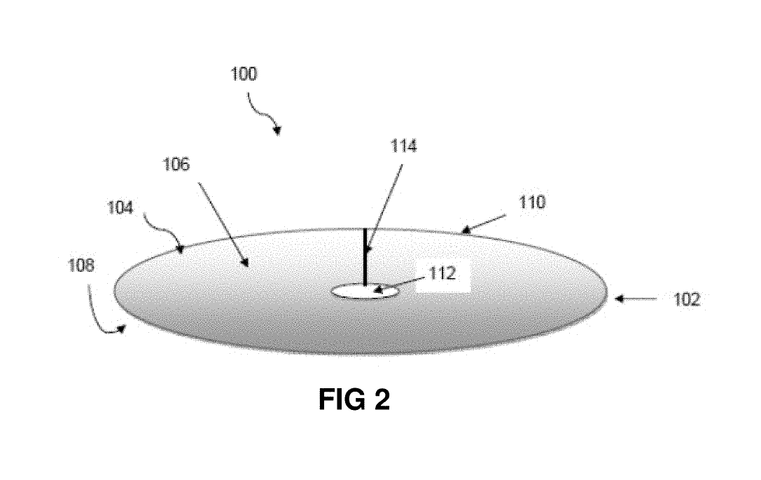

Referring to FIG. 1 and FIG. 2, plan and top perspective views of an insect-trapping horticultural cover or “adhesive pest trap” 100 are shown, according to embodiments of the present invention. The adhesive pest trap 100 comprises a generally thin and substantially planar substrate material 102, having first and second, or top and bottom, substantially parallel surfaces. A first, or top, surface 104 also comprises a coating or layer of adhesive material 106 covering substantially the entire top surface 104 of the substrate material 102, such as a non-drying adhesive or glue-like material, for example. A second, or bottom surface 108 of substrate material 102 is located on the opposite side of the substrate material 102 from the first or top surface 104. In one embodiment, the outer perimeter 110 of the substrate material 102 may be shaped and sized to fit within a plant growing container such as a plant pot or box or against an outer rim of a plant container, and may therefore be shaped substantially as a circle in the case of a substantially circular plant growing pot, or a rectangle in the case of a rectangular plant growing box, for example.

In one embodiment, the adhesive pest trap 100 also comprises a central hole or opening 112 which may desirably be sized and spaced so as to allow for a plant stalk or stem to protrude through the hole 112. In another embodiment, the adhesive pest trap 100 may also further comprise a slit 114 extending from the outer perimeter 110 of the adhesive pest trap 100 towards a substantially central area of the adhesive pest trap 110, so as to allow the trap to be placed around the existing stalk or stem of a plant growing out of a plant growing container. In yet another embodiment, the adhesive pest trap 100 may comprise both a central hole or opening 112 and a slit 114 extending between the central hole 112 and the outer perimeter 110 of the pest trap 100, so as to provide for placement of the trap around an existing plant stalk or stem having a substantial diameter growing out of a plant growing container, for example.

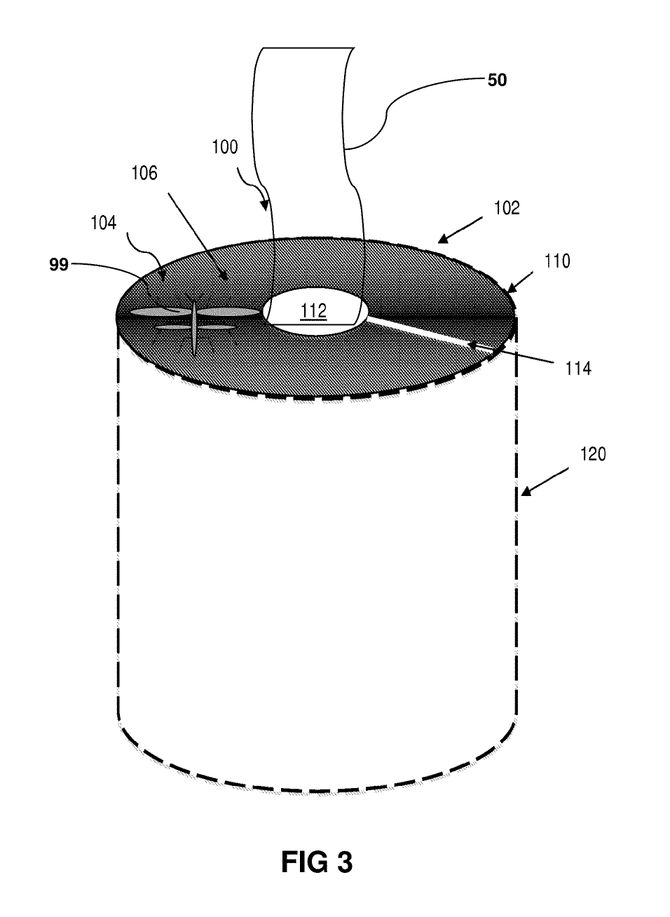

FIG. 3 is a top perspective view of an adhesive pest trap substantially encircling an extruded portion of vegetation and with its annular region being configured as a barrier and substantially covering a soil surface of a plant growing container, according to one exemplary embodiment.

As shown, the insect-trapping horticultural cover (the adhesive pest trap 100) may include a pliable substrate that may be substantially planar such as planar substrate material 102. The pliable substrate may have a top planar surface (top surface 104) and a bottom planar surface (bottom surface 108), where the top planar surface and the bottom planar surface are substantially parallel to each other and on opposing sides of the pliable substrate, as illustrated. Also as illustrated here and throughout, the pliable substrate may include an outer perimeter edge (outer perimeter 110), an inner perimeter edge (opening 112), and a slit 114. The outer perimeter edge is between the top planar surface and the bottom planar surface. Likewise, the inner perimeter edge is between the top planar surface and the bottom planar surface, however the inner perimeter edge may be configured to substantially encircle an extruded portion 50 of vegetation (e.g., a branch, a trunk, or a stem, one or more portions of the vegetation extending from a ground level or hydroponic surface, etc.). Also, the slit 114 may extend between and join the outer perimeter edge 110 to the inner perimeter edge. The adhesive pest trap 100 may also include a non-drying adhesive layer 106 fixed to the top planar surface 104 and configured to prevent an insect 99 from escape after coming into physical contact with non-drying adhesive layer. According to one embodiment, the pliable substrate 102 may be sufficiently pliable and resilient to deformably provide the extruded portion 50 of vegetation passage from the outer perimeter edge to inner perimeter edge, and to return to a substantially planar shape.

In an optional embodiment, the adhesive pest trap 100 may also comprise a central hole or opening 112 which may desirably be sized and spaced so as to allow for a plant stalk or stem to protrude through the hole 112. In another optional embodiment, the adhesive pest trap 100 may also further comprise a slit 114 extending from the outer perimeter 110 of the adhesive pest trap 100 towards a substantially central area of the adhesive pest trap 110, so as to allow the trap to be placed around the existing stalk or stem of a plant growing out of a plant growing container 120. In yet another embodiment, the adhesive pest trap 100 may comprise both a central hole or opening 112 and a slit 114 extending between the central hole 112 and the outer perimeter 110 of the pest trap 100, so as to provide for placement of the trap around an existing plant stalk or stem having a substantial diameter growing out of a plant growing container 120, for example.

As illustrated the adhesive pest trap 100 may be suited for use with a cooperating round plant growing container such as a round plant pot 120. Here, the adhesive pest trap 100 may comprise a substantially circular substrate material 102 with a circular shaped perimeter 110, which may be sized to fit closely and/or sealingly against the round edge of the plant growing container 120 and to cover or overlie substantially all of the upper surface of a soil or other plant growing medium within the plant growing container 120. In another embodiment, suited for use with a cooperating rectangular plant growing container, such as a rectangular or square plant box for example, the adhesive pest trap 100 may comprise a substantially rectangular substrate material 102 with a rectangular shaped perimeter 110, which may be dimensioned to match the cooperating rectangular plant growing container and to fit closely and/or sealingly against the rectangular edge of the plant growing container and cover or overlie substantially all of the upper surface of a soil or other plant growing medium within the plant growing container 120. In both cases, the outer perimeter edge 110 and the inner perimeter edge 112 of the pliable substrate 102 may substantially form an annular region, with said annular region being configured as a barrier to debris and light entering a planter containing the extruded portion of vegetation. This feature may be very advantageous to hydroponic growing. In particular, it may be desirable to keep most, nearly all, or all light out of the vegetation's roots. Moreover by blocking most, nearly all, or all of the upper surface of a soil or other plant growing medium, debris (e.g., leaves, foliage, bugs, dander, animal hair, and other home impurities) may be kept out. This is particularly beneficial for hydroponic media as even plant debris may lead to mold if caught in its plant growing medium.

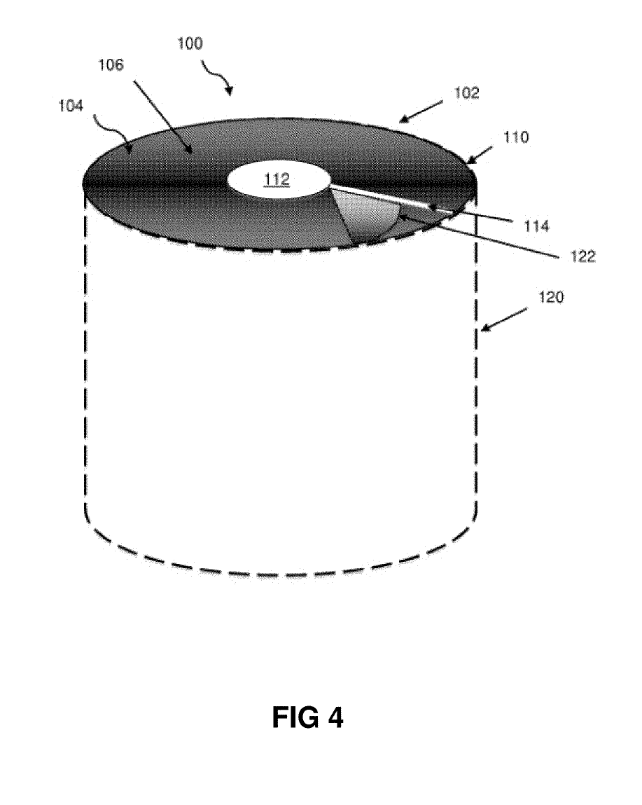

Referring now to FIG. 4, a top perspective view of an adhesive pest trap 100 applied to or placed on top of the upper surface of a plant growing medium in a plant growing container 120 is shown, according to a further embodiment of the present invention. A first, or top, surface 104 comprises a coating or layer of adhesive material 106 covering or overlying substantially the entire top surface 104 of the substrate material 102, such as a non-drying adhesive or glue-like material 106, for example.

In a particular embodiment, the perimeter 110 of the adhesive pest trap 100 may be sized and shaped to fit within a cooperating plant growing container 120 and preferably cover substantially all of the exposed upper surface of a soil substrate or other plant growing substrate located within the plant growing container 120, such that the substrate material 102 preferably fits substantially adjacent to or against the outside edge or rim of the plant growing container 120, and more preferably fits substantially snugly and/or sealingly against the outside edge or rim of the plant growing container 120, such as to substantially prevent pests from entering into the soil or other plant growing substrate from the top of the plant growing container, for example. In another embodiment, the perimeter 110 of the pest trap may be sized and shaped to fit over the outside edge of the plant container.

According to one embodiment, the adhesive pest trap 100 may have its outer perimeter edge 110 configured to physically couple with a rim of a plant growing container 120. In particular, an outer portion of the perimeter 110 of the substrate 102 may be specifically adapted to provide a sealing attachment to or against the outer edge of a plant growing container 120, such as by provision of one or more attachable portions of the perimeter 110 of the substrate 102, which may be attached, such as by adhesive or mechanical means, to the plant growing container 120, so as to effectively secure and/or seal the adhesive trap 100 to the container 120, for example. In one such optional embodiment, one or more adhesive edges or tabs at the perimeter 110 of the substrate 102 may be adapted to sealing attachment to the plant growing container 120, for example.

In an optional embodiment of the present invention, the adhesive pest trap 100 may be adapted for placement on or over a plant growing container but not in direct contact with the surface of the soil or plant growth medium in the plant growing container. In one embodiment of a related method of using an adhesive pest trap, the pest trap 100 may be suspended above the surface of the soil or plant growing medium in a plant growing container, such as by one or more sticks, pins, stakes, or other suitable means, such that the trap 100 is located above the soil surface, but underneath the foliage of a plant growing in the soil, for example.

In another such embodiment, the pest trap 100 may be fitted and/or attached to the inside or outside rim of the plant growing container, such that the adhesive pest trap 100 is suspended above the surface of the soil or plant growing medium inside the plant growing container, such as by attachment or seal to the upper inside or outside rim surfaces of the plant growing container, for example. In one such embodiment, attachment or sealing of the adhesive pest trap 100 to the upper rim surface of the plant growing container may be by adhesive means, such as by adhesion of an adhesive material, such as the adhesive material 106, to the rim of the plant growing container, for example.

According to one exemplary embodiment, the adhesive pest trap 100 may also comprise a removable covering layer 122, which may be removably placed over the top of the adhesive material 106, such as for transport, sale and/or relocation of the pest trap 100, to substantially cover the adhesive material 106 with a non-adhesive surface such as to protect the adhesive material 106 and/or prevent unwanted adhesion of the adhesive material to other objects before placement on a plant growing container, for example. In one such embodiment, the removable covering layer 122 may comprise a thin plastic film which is substantially non-adhesive and may be easily removed and/or replaced over the adhesive material 106.

As such, the adhesive pest trap 100 may further include a removable cover 122 configured to prevent contact with the non-drying adhesive layer 106 prior to removal of the removable cover 122. Beneficially, the removable cover 122 may provide for greater freshness and longer life of the non-drying adhesive layer 106 and/or any additives. In particular, where the non-drying adhesive layer 106 has a limited effective life (i.e., where is retains its “sticky” or non-drying properties) due to exposure, the effective life may be extended by the removable cover 122 interrupting exposure. For example, the non-drying adhesive layer 106 may be further configured to prevent the insect from escape after coming into physical contact with non-drying adhesive layer for at least 6 weeks after removal of the removable cover.

According to one embodiment, a system for protecting indoor plants, the system may be provided, using a plurality of the adhesive pest traps 100. For example, the system may include a plurality of pliable substrates that are substantially planar, with each pliable substrate having a top planar surface and a bottom planar surface, with each top planar surface and bottom planar surface being substantially parallel to the other and on opposing sides of its respective pliable substrate. Here, each pliable substrate may include an outer perimeter edge between its top planar surface and its bottom planar surface, an inner perimeter edge between its top planar surface and its bottom planar surface, said inner perimeter edge configured to substantially encircle an extruded portion of vegetation; and a slit extending between and joining the outer perimeter edge to the inner perimeter edge. Also, a non-drying adhesive layer may be fixed to said top planar surface and configured to prevent an insect from escape after coming into physical contact with said non-drying adhesive layer. Each of the adhesive pest traps 100 may be coupled to and separated by a plurality of removable covers configured to prevent contact with each non-drying adhesive layer prior to removal of its respective removable cover. Here, each of the plurality of pliable substrates may be sufficiently pliable and resilient to deformably provide the extruded portion of vegetation passage from its respective outer perimeter edge to its respective inner perimeter edge, and to return to a substantially planar shape. Also, each non-drying adhesive layer may be interspersed between its respective removable cover and its respective pliable substrate.

In one exemplary embodiment the adhesive pest traps 100 may be adapted for use with standard planters. This may beneficially lower production costs and provide growers with predefined performance. For example, with round plant growing container commonly used in greenhouse horticulture and/or agriculture and having an internal diameter of 11 inches, an adhesive pest trap 100 may comprise a substantially round substrate 102 having an outer diameter of 11 inches, and a thickness of approximately 1 mil, with a substantially circular central opening approximately 3 inches in diameter. Also, for example, where the adhesive material 106 covers substantially the entire top surface 104 of the substrate 102. According to other embodiments, the outer perimeter edge 110 may be substantially round, and have a diameter corresponding to a standard planter, for example measuring one of 12 inches, 6 inches, 3 inches, and 1.5 inches.

Referring now to FIG. 5, a perspective side view of an adhesive pest trap 100, according to an embodiment of the present invention, is shown. Substantially similar to the embodiments shown in FIGS. 1-3, the substrate 102, top adhesive surface 104, bottom surface 108, and perimeter 110 of the adhesive pest trap 100 are shown is the perspective side view of FIG. 4.

In one embodiment according to the present invention, the substrate material 102 of the adhesive pest trap 100 may comprise any suitable substantially planar or sheet-like substrate material suitable for placement on top of a soil or other plant growing medium in a plant growing container or on top of a perimeter or rim of the container, and for receiving the application of a layer or surface of adhesive material 106, such as an adhesive layer comprising a non-drying adhesive or glue, to its top or outer surface 104. In a particular embodiment, the substrate material 102 may comprise any suitable substrate material which may be flexible, pliable, semi-rigid or substantially rigid, so as to provide for support for and adhesion of the adhesive material 106 to the top or outer surface 104 of the substrate 102, and for supporting the adhesive pest trap 100 when placed in contact with or overlying the top surface of soil or another plant growth medium inside a plant growing container 120. In one such embodiment, the substrate material 102 may be selected from substantially planar suitable such materials including but not limited to paper, fabric, cardboard, plastic, cellulose, polymer sheet, metallic foil, metalized polymer foil, or other suitable substrate material, for example.

In a particular embodiment, the second or bottom surface 108 of the substrate 102 may be substantially uncoated and free of adhesive material, such as to allow for easy placement and/or removable placement of the substrate 102 on a soil or plant growing medium such as inside a plant growing container 120, for example. In another embodiment, the bottom surface 108 of the substrate may comprise any desired coating or other material suitable for improving the placement of the substrate 102 on a soil or growing medium, such as a mesh or reinforcing coating or material, or a waterproof coating or material, for example, or may comprise a coating or other material suitable to attach or seal to a perimeter or rim of a plant growing container, such as an adhesive attachment or sealing coating or material, for example.

According to one embodiment, the substrate material 102 may be made of a water-resistant or substantially waterproof material. In particular, both the pliable substrate 102 and the non-drying adhesive layer 106 may at least be water resistant. For example, the pliable substrate 102 may be made of a hydrophobic plastic. Additionally, the non-drying adhesive layer 106 may be non-adhesive to human skin. This may be particularly beneficial where its coverage are or annular region, is configured as a barrier to debris and light entering the planter, substantially blocking passage of moisture and promoting a humid environment without getting soggy or otherwise compromised.

According to one embodiment, the adhesive pest trap 100 may be configured to permit the passage of water. In particular, the substrate material 102 may include perforations or may be made of a water-permeable material. This may be beneficial where the adhesive pest trap 100 acts as a barrier, blocking the ground level, as discussed above, particularly where the adhesive pest trap 100 is water-resistant or water proof, also as discussed above.

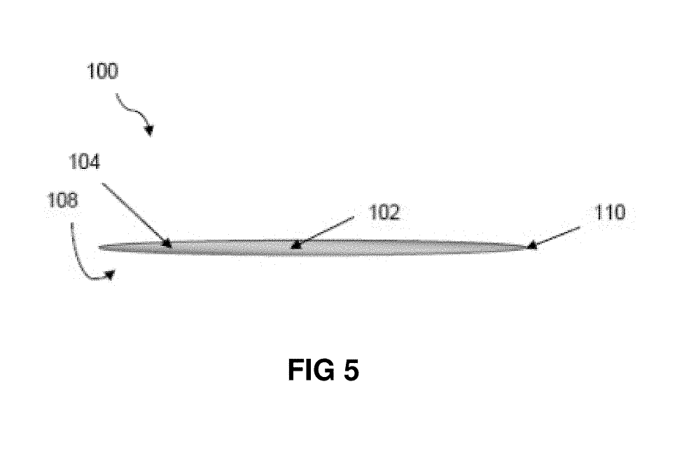

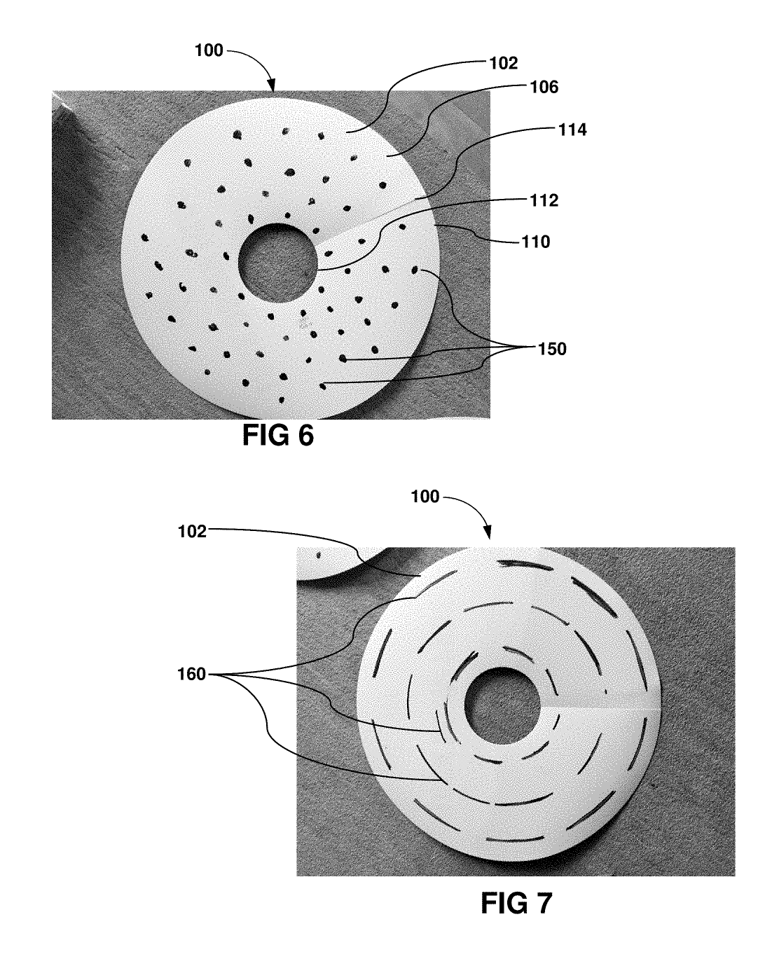

For example, as shown in FIG. 6 the adhesive pest trap 100 may be configured to permit water to pass. In particular, both the pliable substrate 102 and the non-drying adhesive layer 106 may include a plurality of perforations 150 configured to permit water to pass through the pliable substrate 102 and the non-drying adhesive layer 106. Here, perforations 150 are distributed about the entire pliable substrate 102. In alternate embodiments the perforations 150 may be refined for a particular purpose such as allowing gas to escape, allowing humidity to escape, watering holes (allowing water to enter), or catching falling debris such as leaves. According to one embodiment, the perforations 150 may include at least 10 0.25 inch holes. These perforations may be manufactured into the pliable substrate 102 using any convenient means (e.g., punched, drilled, burned, cut, etc.), and may be made individually or in bulk before or after the non-drying adhesive layer 106 is affixed. It should be understood that other permeable configurations are contemplated. For example, FIG. 7 illustrates the pliable substrate 102 with a plurality of slots or arcuate perforations 160 configured to permit water to pass.

Returning now to FIG. 5, in a further embodiment, the substrate 102 may comprise a material selected to be attractive to one or more type of pests desired to be trapped by the adhesive pest trap 100, such as a particular color of material attractive to one or more type of pests, or may comprise a coating or additive which may comprise an attractant to attract one or more type of pest, such as one or more of a coloring, scent, pheromone, or other pest attractant, for example. In an exemplary such embodiment, at least one of the substrate material and/or a coating or additive applied to or added to the substrate material may desirably be provided in any suitable color, such as but not limited to light colors, bright colors, dark colors, or any other suitable color, or combination or range of colors suited for attracting one or more type of pests. According to one embodiment, the adhesive pest trap 100 may include an insect attractant configured to attract insects to the non-drying adhesive layer 106, the insect attractant applied to at least one of the non-drying adhesive layer 106 and the pliable substrate 102.

In an alternative embodiment, it may be desirable to employ any suitable substrate material, and/or a coating or additive applied to or added to the substrate material that may act to repel one or more type of pest, such as one or more of a coloring, scent, pheromone or other pest repellent, for example. According to one embodiment, the adhesive pest trap 100 may include a toxin configured to expedite mortality of the insect after coming into physical contact with non-drying adhesive layer 106, the toxin applied to at least one of the non-drying adhesive layer 106 and the pliable substrate 102.

In another embodiment of the present invention, the adhesive material 106 coating or otherwise applied to at least a portion of the top surface 104 of the substrate 102 may desirably comprise any suitable adhesive material operable for adhesively trapping or otherwise stopping, slowing, repelling or capturing one or more targeted types of pests, such as insects, arthropods, larvae or other types of pests, on the top surface of the adhesive pest trap 100. In one such embodiment, the adhesive material 106 may comprise any suitable tacky or adhesive material, such as non-drying adhesive or glue-based materials as may be known for applications such as flypaper or glueboards, for example. In a particular embodiment, such non-drying adhesive or glue based materials may comprise rubber, polymer, latex, petroleum, oilseed based or any other suitable organic and/or inorganic types of tacky, glue-like or adhesive materials, for example.

In a preferred embodiment of the present invention, the adhesive material 106 may desirably comprise a substantially environmentally friendly or non-toxic non-drying glue or adhesive material. In addition, the adhesive pest trap 100 may be pesticide-free, non-toxic, and/or safe to use indoor and outdoor. Advantageously, the adhesive pest trap 100 may meet regulations for multiple jurisdictions, facilitating import, export, shipping, handling, storage, and the like. According to one embodiment, the adhesive pest trap 100 may include a non-drying adhesive layer 106 that is at least one of non-toxic and unscented.

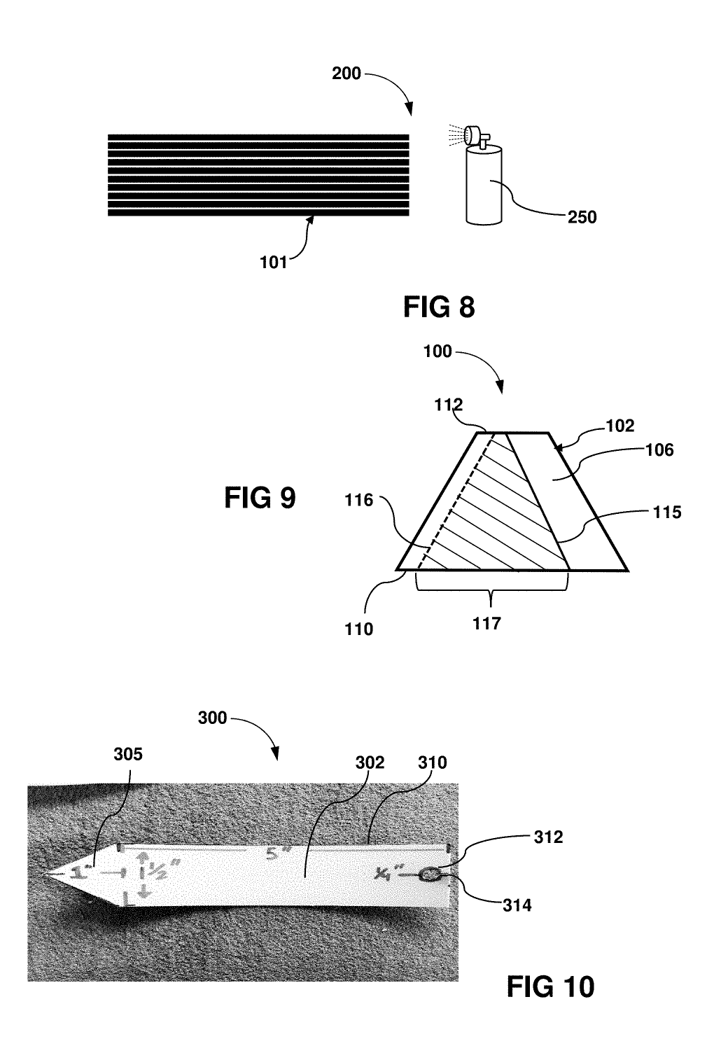

In addition, when combined as the system for protecting indoor plants described above, each non-drying adhesive layer 106 may be at least one of non-toxic and unscented. As shown in FIG. 8, in addition to a plurality of untreated, adhesive pest traps 101, the system for protecting indoor plants 200 may further include a container 250 of at least one of a toxin, an insect attractant, and insect repellant, or controlled substance that is configured to be applied to at least one non-drying adhesive layer after removal of its respective removable cover. As illustrated, the container 250 may be combined with means for applying the contained substance to one or more of the inert the adhesive pest traps 101. Alternately, the means for applying the contained substance may be separated and embodied as brushes, tapes, spouts, and other applicators. In addition to the benefits related to transporting the controlled substances described above, additional benefits may include flexibility in modifying or otherwise directing each untreated adhesive pest trap 101 toward a particular pest. This may be highly desirable where a particular pest of interest is identified though monitoring (e.g., reviewing the number, type, size, etc. of insects adhered to the non-drying adhesive layer 106).

Returning now to FIG. 5, in a further embodiment, the adhesive material 106 may additionally comprise one or more additive, such as but not limited to an attractant (such as a color, scent, and/or pheromone for example) which may be attractive to one or more type of pest, or an insecticide and/or pesticide active against at least one type of pest. According to one embodiment, the adhesive material 106 may be selected for endurance, such as a long lasting, non-drying glue, for use in all seasons. Additional benefits may include an adhesive or glue that doesn't stick to humans, that leaves no residue, and stays effective for at least 6 weeks or at least 12 weeks (e.g., once its removable cover is peeled off).

FIG. 9 is a schematic diagram of an adhesive pest trap in a conical configuration, according to one embodiment of the disclosure. Here, the adhesive pest trap 100 is shown, where the non-drying adhesive layer 106 remains sticky or adhesive to the pliable substrate 102 (e.g., the adhesive is not fixed via a curing process). As illustrated, the non-drying adhesive layer 106 may be adhesive to the bottom planar surface 108 (not shown), and adapted to fix the insect-trapping horticultural cover in a substantially conical configuration when adhered to the bottom planar surface 108. In particular, a first edge 115 of slit 114 (FIG. 1) and a second edge 116 (hidden) of slit 114, when brought around each other form an overlap region 117, where the non-drying adhesive layer 106 is fixed to the bottom planar surface 108 such that the where the non-drying adhesive layer 106 is left upwardly exposed when the outer perimeter edge 110 is positioned below the inner perimeter edge 112. In this way (“cone down”) pest will land on the sticky side. Similarly, where the reverse (“cone up”) catching orientation is desired the first edge 115 of slit 114 and the second edge 116 of slit 114 may be drawn over each other in the reverse fashion and pressed or otherwise fixed to each other via the overlap region 117.

FIG. 10 is a top view of an adhesive pest trap according to an alternate embodiment, and configured to be stabbed in a medium. Here, the adhesive pest trap 300 has two primary methods of fixation. In particular, the adhesive pest trap 300, may be attached to and substantially encircle an extruded portion of vegetation by separating slit 314 in the pliable substrate 302, similarly providing access to inner perimeter edge 312. However, and in addition, the outer perimeter edge 310 of the pliable substrate 302 may include a tapered section 305 configured to manually stick or spike directly into soil or other plant support media. According to the illustrated embodiment, the adhesive pest trap 300 may be generally rectangular, having a width of approximately 1.5 inches, a length of approximately 5 inches, and a tapered section depth of 1 inch. In addition, the inner perimeter edge 312 may be configured for small branches or appendages, for example, and a have a diameter on the order of 0.24 inch.

In one embodiment of a related method of using an adhesive pest trap, a pest trap 100 is provided and configured for fitting substantially adjacent to or against or sealingly against the outside edge of the plant growing container 120, and the pest trap 100 is then placed over the top surface of the plant growing medium inside the plant growing container. In one such embodiment, the pest trap 100 may be configured and placed in the plant growing container so as to substantially cover all of the top surface of the plant growing medium inside the container, and further may preferably be fitted substantially snugly and/or sealingly against the outside edge or rim of the container 120, such as to substantially prevent pests from entering into the soil or other plant growing substrate from the top of the plant growing container, for example. In another embodiment, the perimeter 110 of the pest trap 100 may be sized and shaped to fit over the outside edge of the plant container, and may be placed over the outside edge of the container over top of the plant growing medium within.

A method of using the pest trap 100 may include merely flexing the slit of the pest trap 100 and place the inner cut out around the base of your plant and lay flat. In addition, a protective sheeting may be peeled off, and the pest trap 100 will catch insects until covered with debris. The pest trap 100 may attract insects such as: aphids, fungus gnats, leafminers, spider mites, whiteflies, thrips, fruit flies, as well as others.

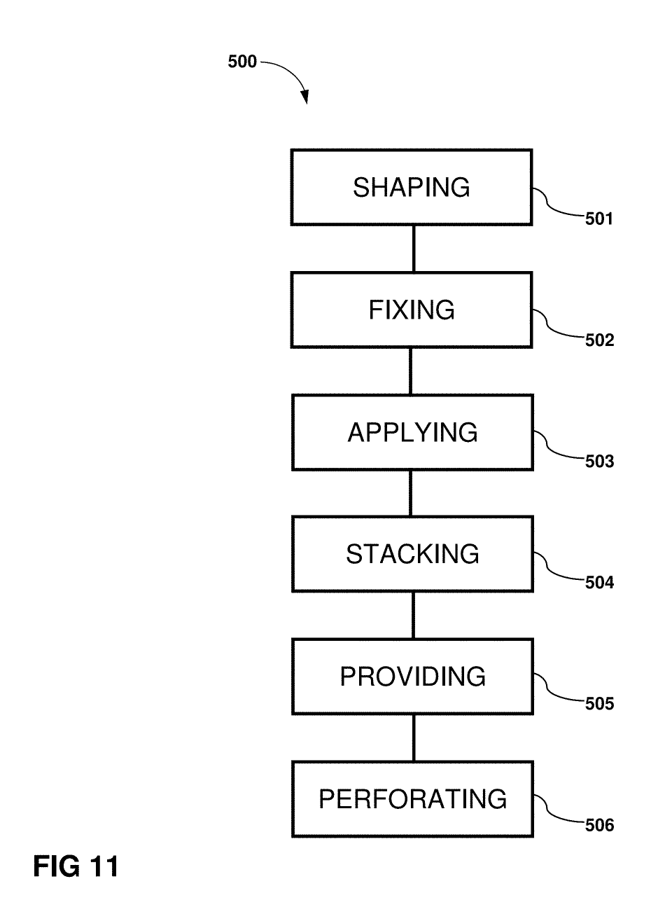

FIG. 11 is a flow diagram showing method of manufacture 500, according to an embodiment of the disclosure. The method may include the steps of 501, shaping a plurality of pliable substrates that are substantially planar, each pliable substrate having a top planar surface and a bottom planar surface, with each top planar surface and bottom planar surface being substantially parallel to each other and on opposing sides of their respective pliable substrate, each pliable substrate including an outer perimeter edge, an inner perimeter edge, and a slit extending between and joining said outer perimeter edge to said inner perimeter edge, such that each pliable substrate has a substantially annular shape, said inner perimeter edge configured to substantially encircle an extruded portion of vegetation. Step 502, fixing a plurality of non-drying adhesive layers to said top planar surface of each of the plurality of pliable substrates, each non-drying adhesive layer configured to prevent an insect from escape after coming into physical contact with said non-drying adhesive layer. Step 503, applying a plurality of removable covers to each of the plurality of non-drying adhesive layers, respectively, each non-drying adhesive layer being interspersed between its respective removable cover and its respective pliable substrate. Step 504, stacking together each of the plurality of pliable substrates having its respective non-drying adhesive layer fixed and its respective removable cover applied.

According to one embodiment, each of the plurality of pliable substrates may be sufficiently pliable and resilient to deformably provide the extruded portion of vegetation passage from its respective outer perimeter edge to its respective inner perimeter edge, and to return to a substantially planar shape. According to another embodiment, each non-drying adhesive layer may be at least one of non-toxic and unscented, and the method 500 may further include step 505, providing a sealed container containing at least one of a toxin and an insect attractant. According to another embodiment, at least one of the toxin and the insect attractant may be configured to be applied to at least one non-drying adhesive layer after removal of its respective removable cover. According to yet another embodiment, method 500 may also include step 506, perforating each of the plurality of pliable substrates with an array of perforations configured to permit water to pass through

Aspects of the system and method may include monitoring insects, in addition to locking them down. In particular, in some instances it may be desirable to monitor pests as well. In particular, knowledge about what type(s) of insect is present, and/or how many are involved may be valuable in treating the problem and/or knowing the effectiveness of protections in place. Also, in indoor applications (particularly in homes), it may be desirable to not only neutralize the pest, but to prevent it from traveling elsewhere in the home. This is particularly true where toxic chemicals are used to kill the pests. Finally, with regard to indoor hydroponic growing and insect monitoring, a mere barrier/deterrent may allow crawling insects and other pests to go undetected and remain free to roam to other parts of the home, proximate the hydroponic plants.

The systems and devices disclosed may provide innovative insect monitoring solutions. For example, the pest traps described may allow insect monitoring with the smallest environmental impact possible. For example, using a yellow, sticky substrate with nontoxic non-drying adhesive, a wide range of insects, including fungus gnats, thrips, spider mites, leaf miners, aphids, whiteflies, fruit flies, and more may be attracted and trapped while user is not present, but retained for further understanding, analysis, and adaption.

As described throughout the present disclosure, the devices, systems, and methods disclosed may provide advantages and benefits to persons with skill in the art, and may lead to the growing demand by consumers for these products, offering a product that is pesticide-free for gardens, flowers, houseplants, insects and more. In addition to the providing for monitoring pests and adapting to trends or changes, the devices, systems, and methods disclosed may also help assist in the safety of homes or businesses. Particular benefits may include indoor horticulture products that are non-toxic and non-gassing. In addition, efficient heat shrink packaging may be used, and mitigated shipping (including cross border) may be provided, particularly where there are no chemicals/pheromones or where they are contained separately in sealed containers. Moreover, through monitoring and separation of chemicals/pheromones bug specific variability may be provided within a single product or system for protecting indoor plants.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings. As will be apparent to those skilled in the art in light of the foregoing disclosure, many alterations and modifications are possible in the practice of this invention without departing from the scope thereof.

1. An insect-trapping horticultural cover comprising:
a pliable substrate that is substantially planar, the pliable substrate having a top planar surface and a bottom planar surface, the top planar surface and the bottom planar surface being substantially parallel to each other and on opposing sides of the pliable substrate, the pliable substrate including:
an outer perimeter edge between the top planar surface and the bottom planar surface, the bottom planar surface is configured to physically couple with a rim of a plant growing container wherein the bottom planar surface extends beyond the rim of the plant growing container wherein the bottom planar surface and the rim of the plant growing container together establish a continuous boundary around the plant growing container;
an inner variable-perimeter edge between the top planar surface and the bottom planar surface, the inner variable-perimeter edge configured to substantially encircle an extruded portion of vegetation, and flexibly-sized and spaced so as to allow for the extruded portion of vegetation to protrude through during a life-cycle of the vegetation;
a slit extending between and joining the outer perimeter edge to the inner perimeter edge; and
a non-drying adhesive layer fixed to the top planar surface extending continuously over a majority of the top planar surface and extending beyond the rim of the plant growing container to and including the outer perimeter edge and configured to prevent an insect from escape after coming into physical contact with the non-drying adhesive layer;
wherein the pliable substrate is sufficiently pliable and resilient to deformably provide the extruded portion of vegetation passage from the outer perimeter edge to the inner perimeter edge, and to return to a substantially planar shape.

2. The insect-trapping horticultural cover of claim 1, further comprising a removable cover configured to prevent contact with the non-drying adhesive layer prior to removal of the removable cover;
wherein the non-drying adhesive layer is interspersed between the removable cover and the pliable substrate; and
wherein the non-drying adhesive layer is further configured to prevent the insect from escape after coming into physical contact with non-drying adhesive layer for at least 6 weeks after removal of the removable cover.

3. The insect-trapping horticultural cover of claim 1, wherein the non-drying adhesive layer is at least one of non-toxic and unscented.

4. The insect-trapping horticultural cover of claim 1, further comprising an insect attractant configured to attract insects to the non-drying adhesive layer, the insect attractant applied to at least one of the non-drying adhesive layer and the pliable substrate.

5. The insect-trapping horticultural cover of claim 1, further comprising a toxin configured to expedite mortality of the insect after coming into physical contact with non-drying adhesive layer, the toxin applied to at least one of the non-drying adhesive layer and the pliable substrate.

6. The insect-trapping horticultural cover of claim 1, wherein the outer perimeter edge and the inner perimeter edge of the pliable substrate substantially form an annular region, said annular region being configured as a barrier to debris and light entering a planter containing the extruded portion of vegetation;
wherein both the pliable substrate and the non-drying adhesive layer are at least water resistant; and
wherein both the pliable substrate and the non-drying adhesive layer include a plurality of perforations configured to permit water to pass through the pliable substrate and the non-drying adhesive layer.

7. The insect-trapping horticultural cover of claim 1, wherein the non-drying adhesive layer is non-adhesive to human skin.

8. The insect-trapping horticultural cover of claim 1, wherein the non-drying adhesive layer is adhesive to the bottom planar surface, and adapted to fix the insect-trapping horticultural cover in a substantially conical configuration when adhered to the bottom planar surface.

9. The insect-trapping horticultural cover of claim 1, wherein the outer perimeter edge is configured to physically couple with a rim of a plant growing container.

10. The insect-trapping horticultural cover of claim 1, wherein the outer perimeter edge is substantially round, and has a diameter corresponding to a standard planter, said diameter measuring one of 12 inches, 6 inches, 3 inches, and 1.5 inches.

11. A system for protecting indoor plants, the system comprising:
a plurality of pliable substrates that are substantially planar, each pliable substrate having a top planar surface and a bottom planar surface, with each top planar surface and bottom planar surface being substantially parallel to the other and on opposing sides of its respective pliable substrate, each pliable substrate including
an outer perimeter edge between its top planar surface and its bottom planar surface,
an inner perimeter edge between its top planar surface and its bottom planar surface, said inner perimeter edge configured to substantially encircle an extruded portion of vegetation,
a slit extending between and joining the outer perimeter edge to the inner perimeter edge, and
a non-drying adhesive layer fixed to said top planar surface and configured to prevent an insect from escape after coming into physical contact with said non-drying adhesive layer; and
a plurality of removable covers configured to prevent contact with each non-drying adhesive layer prior to removal of its respective removable cover;
wherein each of the plurality of pliable substrates is sufficiently pliable and resilient to deformably provide the extruded portion of vegetation passage from its respective outer perimeter edge to its respective inner perimeter edge, and to return to a substantially planar shape; and
wherein each non-drying adhesive layer is interspersed between its respective removable cover and its respective pliable substrate.

12. The system of claim 11, wherein each non-drying adhesive layer is at least one of non-toxic and unscented, and the system further comprises a container of at least one of a toxin and an insect attractant that is configured to be applied to at least one non-drying adhesive layer after removal of its respective removable cover.

13. The system of claim 11, wherein each pliable substrate further includes at least one of an insect attractant configured to attract insects to the non-drying adhesive layer and a toxin configured to expedite mortality of the insect after coming into physical contact with its respective non-drying adhesive layer.

14. The system of claim 11, wherein the outer perimeter edge and the inner perimeter edge of each of the plurality of pliable substrates substantially form an annular region, respectively, said annular region being configured as a barrier to debris and light entering a planter containing the extruded portion of vegetation;
wherein each non-drying adhesive layer is at least water resistant;
wherein each of the plurality of pliable substrates is at least water resistant; and
wherein each of the plurality of pliable substrates further includes a plurality of perforations configured to permit water to pass through its respective pliable substrate.

15. The system of claim 11, wherein each outer perimeter edge of each of the plurality of pliable substrates includes a tapered section configured to manually stick directly into soil

16. The system of claim 11, wherein each of the plurality of pliable substrates are reconfigurable between a substantially planar configuration and a substantially conical configuration via attachment of its respective non-drying adhesive layer to its respective bottom planar surface.

17. The system of claim 11, wherein each of the plurality of pliable substrates are made of a material selected from the list comprising: paper, fabric, cardboard, plastic, cellulose, polymer, metallic foil, metalized polymer foil, and combinations thereof.

18. A method of manufacturing a system of claim 17 for protecting indoor plants, the method comprising:
shaping a plurality of pliable substrates that are substantially planar, each pliable substrate having a top planar surface and a bottom planar surface, with each top planar surface and bottom planar surface being substantially parallel to each other and on opposing sides of their respective pliable substrate, each pliable substrate including an outer perimeter edge, an inner perimeter edge, and a slit extending between and joining said outer perimeter edge to said inner perimeter edge, such that each pliable substrate has a substantially annular shape, said inner perimeter edge configured to substantially encircle an extruded portion of vegetation;
fixing a plurality of non-drying adhesive layers to said top planar surface of each of the plurality of pliable substrates, each non-drying adhesive layer configured to prevent an insect from escape after coming into physical contact with said non-drying adhesive layer;
applying a plurality of removable covers to each of the plurality of non-drying adhesive layers, respectively, each non-drying adhesive layer being interspersed between its respective removable cover and its respective pliable substrate;
stacking together each of the plurality of pliable substrates having its respective non-drying adhesive layer fixed and its respective removable cover applied; and
wherein each of the plurality of pliable substrates is sufficiently pliable and resilient to deformably provide the extruded portion of vegetation passage from its respective outer perimeter edge to its respective inner perimeter edge, and to return to a substantially planar shape.

19. The method of claim 18, wherein each non-drying adhesive layer is at least one of non-toxic and unscented, the method further comprising providing a sealed container containing at least one of a toxin and an insect attractant; and
wherein the at least one of the toxin and the insect attractant are configured to be applied to at least one non-drying adhesive layer after removal of its respective removable cover.

20. The method of claim 18, further comprising perforating each of the plurality of pliable substrates with an array of perforations configured to permit water to pass through its respective pliable substrate.
